(19) United States
(12) Patent Application Publication
(10) Pub. No.: US 2009/0025677 A1
(43) Pub. Date: Jan. 29, 2009

(54) COMBUSTION ENGINE OF THE IMPULSE TYPE

(76) Inventor: Hendrikus Peter van der Waal, Den Haag (NL)

Correspondence Address: LAUBSCHER & LAUBSCHER, P.C., 1160 SPA ROAD, SUITE 2B, ANNAPOLIS, MD, 21403, US

(21) Appl. No.: 12/161,216

(22) PCT Filed: Jan. 23, 2007
(86) PCT No.: PCT/NL2007/000020

§ 371 Date: Jul. 17, 2008

(30) Foreign Application Priority Data
Jan. 25, 2006 (NL) NL 1030997
Jan. 23, 2007 (NL) PCT/NL2007/00020

(51) Int. Cl. F02B 53/04

(52) U.S. Cl. 123/231

(57) ABSTRACT

A combustion engine comprising a mainly cylindrical housing (5) provided with means for supplying an air-fuel mixture to a number of combustion chambers (3), provided on the outside of said housing, with a shaft (2) rotating in said housing and means (9) for exhausting flue-gas. Inside said housing (5) said shaft (2) is provided with a number of vanes (1) being fixed to said shaft and extending along said shaft and in radial direction of it, each of said vanes along an edge end of it and near the wall (7) of said housing (5), being provided with an edge element (6) extending from said edge end and along the wall (7) of said housing (5), said element ending at a distance from the adjacent vane (1). Said combustion chambers (3) is provided with an inlet valve (10) for controlling the supply of air-fuel mixture and of ignition means (11) for said mixture and of a discharge channel (12) for flue-gas extending through the wall (7) of said housing (5) and debouching into the interior of said housing. Said housing (5) is further provided with a number of outlet channels (9).

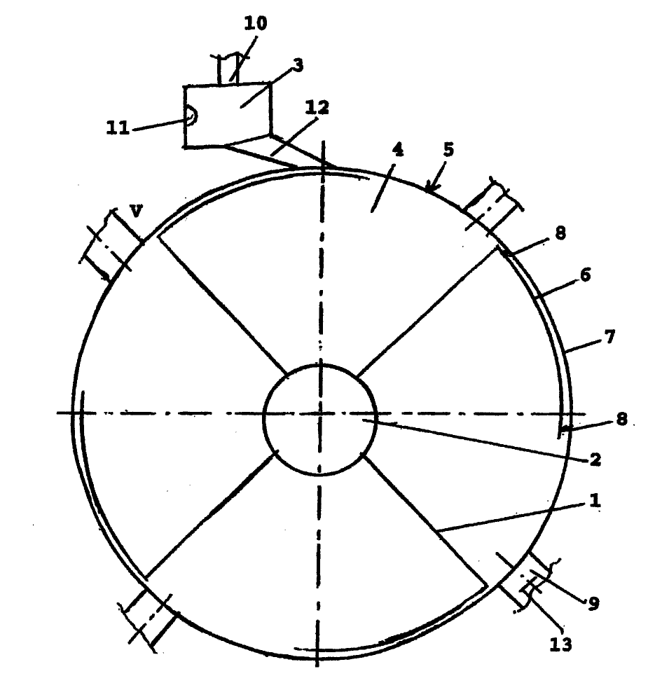

The invention relates to a combustion engine comprising a housing provided with at least one combustion chamber, means for supplying an air-fuel mixture which has to be burned to said combustion chamber, a shaft which is rotatable supported in said housing and means for exhausting flue-gas.

Such an engine, for example, is known as an engine of the “Wankel”- kind. In such an engine it is not necessary to transfer a to and fro movement into a rotating movement. Nevertheless it has appeared, that the efficiency of such an engine is not better than that of the generally known piston-engines with pistons moving to and fro.

The object of the invention is to provide a combustion engine in which no transfering of a to and fro movement into a rotating movement is necessary.

According to the invention this is obtained by that in a mainly cylindrical housing a shaft, coinciding with the axis of the housing, is rotatably supported, said shaft being provided with a number of vanes being fixed to said shaft and extending along said shaft and in radial direction of it, each of said vanes along an edge end of it and near the wall of said housing, being provided with an edge element extending from said edge end and along the wall of said housing, said element ending at a distance from the adjacent vane, the outside of said housing being provided with the same number of combustion chambers provided with an inlet valve for controlling the supply of air-fuel mixture and of ignition means for said mixture and of a discharge channel for flue-gas extending through the wall of said housing and debouching into the interior of said housing, said housing being provided with the same number of outlet channels.

The purpose of such an assembly is that the flue-gas leaving said discharge channel acts upon the vane which, together with its preceding edge element, has just passed the discharge channel so that by means of said vane the shaft is brought into rotation and held in this.

Said edge element serves for the temporary closing of the discharge channel of the combustion chamber so that caused by this the mixture which has to be burned can be supplied to said combustion chamber.

To enhance the effect of the flue-gases on said vanes as much as possible, it will be prefered that said discharge channel will extend itself mainly tangentially in respect of the wall of said housing and the width of it will nearly correspond to the width of said vane.

By this it is prevented that the arriving next vane is influenced by the gasflow acting upon the preceding vane.

Said edge element connected to the vane also serves to close said outlet channel temporary.

For closing said outlet channel temporary this also might be provided with a controlled valve.

By this the point of time for opening and closing the outlet channel can be more exactly controlled.

The invention is further elucidated by means of an embodiment being very schematically shown in the drawing.

Said drawing shows a radial section in which four vanes 1 are present on a shaft 2 but in which of the four combustion chambers 3 belonging to it only one is shown more specific.

The shaft 2 is rotatably supported in the end walls 4 of a housing 5. The vanes 1 are provided with edge elements 6, extending along the wall 7 of said housing 5 and being tightend in respect of this wall as e.g. by washer strips 8. Further the housing 5 is provided with outlet channels 9.

Via the valve 10 air-fuel mixture is supplied to the combustion chamber 3 and is ignitioned by means of the ignition plug 11. The flue-gas is discharged through the discharge channel 12, which substantially tangential debouches in the wall 7 of the housing 5.

In the position of the shaft 2 shown in the drawing said discharge channel 12 is closed by said edge element 6. When the shaft 2 rotates further, in the direction of the arrow V, said vane 1 will be in a position directly after said discharge channel and at that moment the air-fuel mixture will be ignitioned. The flue-gas flowing out of said discharge channel 12 will act upon the vane 1 and will take care for it that the shaft rotates further. When the shaft 2 is rotated over a given angle the outlet channel 9 is opened for dicharging said flue-gas to a manifold not further indicated.

As already indicated said outlet channel 9 might be provided with a controlled valve 13 by which the discharge of flue-gas can be controlled more exactly.

It will be obvious that only one possible embodiment of an engine according to the invention is shown in the drawing and is described above and that many modifications can be made without leaving the scope of the invention as this is indicated in the claims.

So it might be concluded that the basic idea can be found in it that the above description concerns a shaft-to-shaft construction without which said indicated means cannot be applied when these are not assembled with the shaft, so that the shaft-to-shaft construction is forming one whole by which the crank shaft principle is made superfluous.

1. Combustion engine comprising a housing (5) provided with at least one combustion chamber (3), means for supplying an air-fuel mixture which has to be burned to said combustion chamber, a shaft (2) which is rotatable supported in said housing and means (9) for exhausting flue-gas, characterized in that in a mainly cylindrical housing (5) a shaft (2), coinciding with the axis of the housing, is rotatably supported, said shaft being provided with a number of vanes (1) being fixed to said shaft and extending along said shaft and in radial direction of it, each of said vanes along an edge end of it an near the wall (7) of said housing (5), being provided with an edge element (6) extending from said edge end and along the wall (7) of said housing (5), said element ending at a distance from the adjacent vane (1), the outside of said housing (5) bing provided with the same number of combustion chambers (3) provided with an inlet valve (10) for controlling the supply of air-fuel mixture and of ignition means (11) for said mixture and of a discharge channel (12) for flue-gas extending through the wall (7) of said housing (5) and debauching into the interior of said housing, said housing being provided with the same number of outlet channels (9).

2. Combustion engine according to claim 1, characterized in that said discharge channel (12) extends itself mainly tangentially in respect of the wall (7) of said housing (5) and in the width of it will nearly correspond to the width of said vane (1).

3. Combustion engine according to claim 1, characterized in that for closing said outlet channel (9) temporary this is provided with a controlled valve (13).
